(19) United States
(12) Patent Application Publication
(10) Pub. No.: US 2026/0154297 A1
(43) Pub. Date: Jun. 4, 2026

(54) CONTINUOUS AUGMENTED GENERATION WITH CHAIN OF THOUGHT

(71) Applicant: Pulse AI Inc., West Saint Paul, MN (US)

(72) Inventor: Matthew Krueger, West Saint Paul, MN (US)

(21) Appl. No.: 19/368,526

(22) Filed: Oct. 24, 2025

Related U.S. Application Data
(60) Provisional application No. 63/727,630, filed on Dec. 3, 2024.

(51) Int. Cl. G06F 16/332

(52) U.S. Cl. CPC G06F 16/3326

(57) ABSTRACT

A computer-implemented method of providing continuous retrieval-augmented generation chain-of-thought (CRAG-CoT) processing for an artificial intelligence (AI) model. The method includes receiving an input prompt and instructing a first AI model to assess the input prompt using a base prompt, the base prompt including syntax instructions for intermediate responses generated by the first AI model. The first AI model generates a plurality of reasoning steps using the syntax instructions of the base prompt and data is retrieved from at least one data source corresponding to each reasoning step of the plurality of reasoning steps. At least a portion of the plurality of reasoning steps and the retrieved data are provided to a second AI model that generates a final response based on the input prompt.

### CROSS-REFERENCE TO RELATED APPLICATIONS

This application claims priority to U.S. Provisional Application No. 63/727,630, titled “CONTINUOUS RETRIEVAL AUGMENTED GENERATION WITH CHAIN OF THOUGHT AND ASSOCIATED APPLICATIONS” and filed on Dec. 3, 2024, the entire disclosure of which is hereby incorporated by reference herein.

### TECHNICAL FIELD OF THE INVENTION

The present disclosure relates to retrieval-augmented generation (RAG) techniques for artificial intelligence (AI) applications and, more specifically, to continuous RAG techniques with chain-of-thought (CoT) reasoning.

### BACKGROUND

Prompt-response interactions with artificial intelligence (AI) models are used to generate dynamic outputs based on user-provided input prompts. The prompt typically includes a natural language query, command, or instruction, which is processed by an AI model, such as a large language model (LLM). The AI model generates a corresponding response based on its training data and learned patterns of language. However, many AI models suffer from hallucinations, providing inaccurate responses that appear accurate to the AI model due to its training.

To enhance the relevance and factual accuracy of generated responses, retrieval-augmented generation (RAG) techniques may be employed. In a RAG-based system, the input prompt is first used to query an external knowledge base, document store, or search index to retrieve contextually relevant documents or data. The retrieved results are then incorporated into the prompt or fed into the AI model's context window, allowing the AI model to ground its response in real-time information or domain-specific knowledge. This combination of retrieval and generation enables more precise, context-aware outputs and improves performance in tasks requiring up-to-date or specialized information. However, RAG-based systems struggle with prompts that involve complex multi-step reasoning.

In some cases, chain-of-thought (CoT) reasoning techniques may be utilized to improve the accuracy and interpretability of outputs generated from prompts that involve multi-step reasoning. CoT reasoning involves prompting the AI model to produce intermediate reasoning steps that explicitly reflect a logical progression toward the final answer. Rather than generating a direct response to a query, the AI model is instructed—either implicitly through training data or explicitly via prompt engineering—to “think aloud” by decomposing the task into a sequence of coherent, contextually relevant sub-steps. However, the amount of time the AI model spends “thinking” is not configurable for the user, resulting in unresponsive services and unexpected spikes in cost and utility consumption. In addition, combining CoT reasoning with RAG-based techniques can lead to significant processing delays that are too slow to deliver a satisfactory user experience.

### SUMMARY OF THE INVENTION

In various examples, the subject matter of this disclosure relates to improved techniques for retrieval-augmented generation (RAG) with chain-of-thought (CoT) reasoning.

At least one aspect of the present disclosure is directed to a computer-implemented method of providing continuous retrieval-augmented generation chain-of-thought (CRAG-CoT) processing for an artificial intelligence (AI) model. The method includes receiving an input prompt and instructing a first AI model to assess the input prompt using a base prompt. The base prompt includes syntax instructions for intermediate responses generated by the first AI model. The first AI model generates a plurality of reasoning steps using the syntax instructions of the base prompt and data is retrieved from at least one data source corresponding to each reasoning step of the plurality of reasoning steps. At least a portion of the plurality of reasoning steps and the retrieved data are provided to a second AI model that generates a final response based on the input prompt.

In some embodiments, the first AI model and the second AI model are the same AI model. In some embodiments, at least one of the first AI model and the second AI model is a large language model (LLM). In some embodiments, the plurality of reasoning steps correspond to chain-of-thought (CoT) processing steps. In some embodiments, retrieving data from the at least one data source corresponding to each reasoning step of the plurality of reasoning steps includes using at least one application programming interface (API) to search the at least one data source. In some embodiments, at least one API call is generated for each reasoning step of the plurality of reasoning steps. In some embodiments, the at least one data source includes at least one of a vectorized database and a backend web application. In some embodiments, each reasoning step of the plurality of reasoning steps includes a search response, a thought response, and a result response generated by the first AI model. In some embodiments, the syntax instructions include formatting for each search response, thought response, and result response generated by the first AI model. In some embodiments, retrieving data from the at least one data source corresponding to each reasoning step of the plurality of reasoning steps includes searching the at least one data source using the corresponding search response. In some embodiments, the method includes sorting, via a syntax interpreter, the retrieved data for each search response into a first data basket and the corresponding thought and result responses into a second data basket. In some embodiments, providing at least a portion of the plurality of reasoning steps and the retrieved data to the second AI model includes providing the data of the first and second data baskets to the second AI model.

Another aspect of the present disclosure is directed to a system for providing continuous retrieval-augmented generation chain-of-thought (CRAG-CoT) processing for an artificial intelligence (AI) model. The system includes at least one memory for storing computer-executable instructions and at least one processor for executing the instructions stored on the at least one memory. Execution of the instructions programs the at least one processor to perform operations that include receiving an input prompt and instructing a first AI model to assess the input prompt using a base prompt, the base prompt including syntax instructions for intermediate responses generated by the first AI model. The first AI model generates a plurality of reasoning steps using the syntax instructions of the base prompt and data is retrieved from at least one data source corresponding to each reasoning step of the plurality of reasoning steps. At least a portion of the plurality of reasoning steps and the retrieved data are provided to a second AI model that generates a final response based on the input prompt.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 illustrates a block diagram of an example prompt-response interaction in accordance with aspects described herein;

FIG. 2 illustrates a block diagram of a retrieval-augmented generation (RAG) interaction in accordance with aspects described herein;

FIG. 3 illustrates a block diagram of a chain-of-thought (CoT) interaction in accordance with aspects described herein;

FIG. 4 illustrates a block diagram of a continuous RAG CoT (CRAG-CoT) system in accordance with aspects described herein;

FIG. 5 illustrates a flow process of the CRAG-CoT system of FIG. 4 in accordance with aspects described herein;

FIG. 6 illustrates a block diagram of a CRAG-CoT engine in accordance with aspects described herein;

FIG. 7 illustrates an example base prompt in accordance with aspects described herein;

FIG. 8A illustrates an example reasoning step in accordance with aspects described herein;

FIG. 8B illustrates an example reasoning step in accordance with aspects described herein;

FIG. 8C illustrates an example reasoning step in accordance with aspects described herein;

FIG. 9 illustrates an example final response in accordance with aspects described herein;

FIG. 10 illustrates a block diagram of a CRAG-CoT system in accordance with aspects described herein;

FIG. 11 illustrates a block diagram of a CRAG-CoT system in accordance with aspects described herein;

FIG. 12 illustrates a block diagram of a CRAG-CoT system in accordance with aspects described herein;

FIG. 13 illustrates a block diagram of a CRAG-CoT system in accordance with aspects described herein;

FIG. 14 illustrates a block diagram of a hierarchal agent collaboration (HAC) system in accordance with aspects described herein;

FIG. 15 illustrates a hierarchical agent organization structure in accordance with aspects described herein; and

FIG. 16 illustrates an example computer system.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

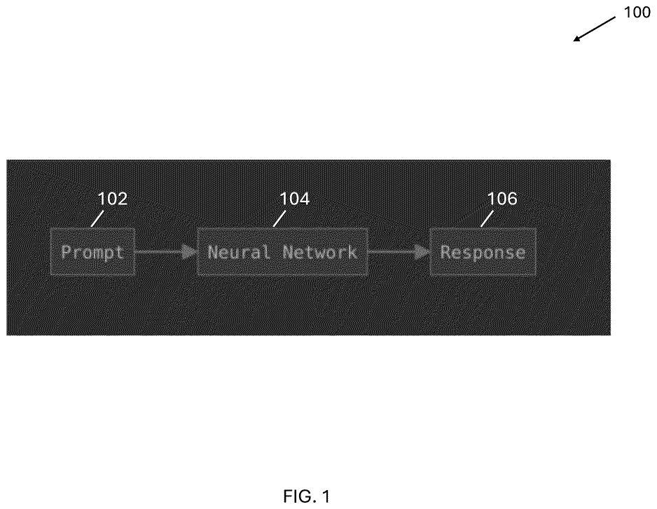

As discussed above, prompt-response interactions with artificial intelligence (AI) models are used to generate dynamic outputs based on user-provided input prompts. FIG. 1 illustrates an example of a prompt-response interaction 100. The prompt 102 may include a natural language query, command, or instruction, which is processed by the AI model 104 (e.g., a neural network model). The AI model 104 generates a corresponding response 106 based on its training data and learned patterns of language. However, in some cases, the AI model 104 may “hallucinate” the response 106, providing an inaccurate response that appears accurate to the AI model 104 due to its training.

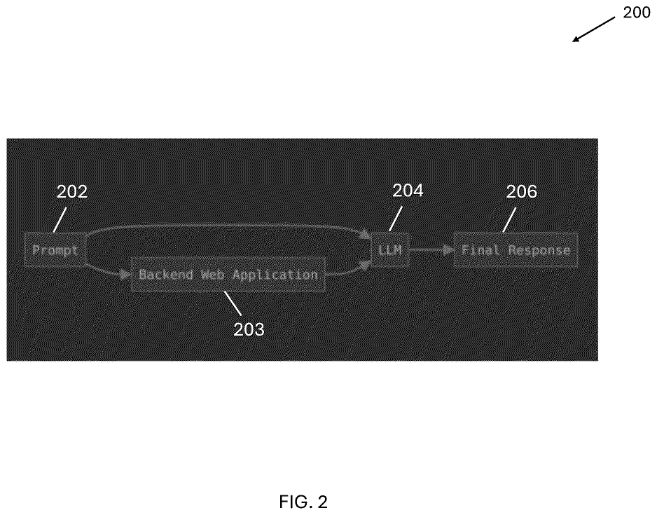

To enhance the relevance and factual accuracy of generated responses, retrieval-augmented generation (RAG) techniques may be employed with AI models. FIG. 2 illustrates an example of a RAG-based interaction 200. In a RAG-based system, the input prompt 202 is first used to query a data source 203 (e.g., a backend web application) to retrieve contextually relevant documents or data. In some cases, the data source 203 is an external knowledge base, a document store, or a search index. The retrieved results are then incorporated into the prompt 202 or fed into a context window of the AI model 204 (e.g., a large language model (LLM)). In some cases, the retrieved results are presented to the AI model 204 based on semantic similarity or other characteristics. This process allows the AI model 204 to ground its response 206 in real-time information or domain-specific knowledge, instead of relying entirely on its training data. This combination of retrieval and generation enables more precise, context-aware outputs and improves performance in tasks requiring up-to-date or specialized information. However, even with the use of RAG techniques, the AI model 204 may struggle with a prompt 202 that involves complex multi-step reasoning. This is because the retrieval step provides for one “shot” at a search, meaning a bad initial search prompt will create a garbage-in, garbage-out scenario and the AI model 204 will be forced to summarize from poor or limited results.

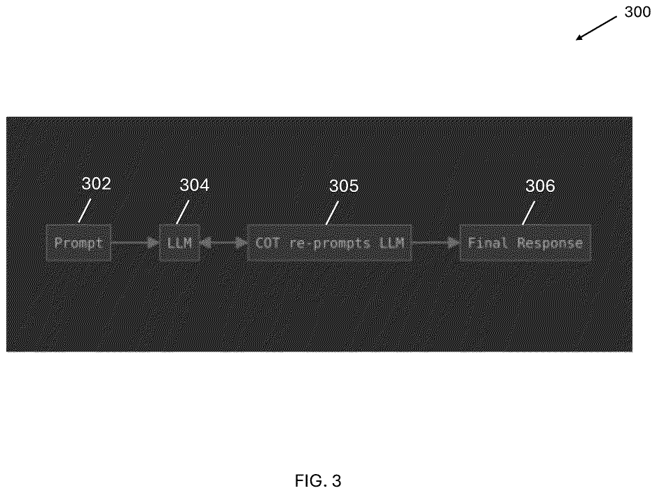

In some cases, chain-of-thought (CoT) reasoning techniques may be utilized to improve the accuracy and interpretability of outputs generated from prompts that involve multi-step reasoning. FIG. 3 illustrates an example of a CoT-based interaction 300. In a CoT-based system, the input prompt 302 is delivered to the AI model 304 (e.g., an LLM) to produce intermediate reasoning steps that explicitly reflect a logical progression toward the final answer. Rather than generating a direct response to a query, the AI model 304 is instructed—either implicitly through training data or explicitly via prompt engineering—to “think aloud” by decomposing the task into a sequence of coherent, contextually relevant sub-steps. Such sub-steps are constructed as new prompts 305 that are used to re-prompt the AI model 304 before generating the final response 306. However, the amount of time the AI model 304 spends “thinking” is not configurable for the user, resulting in unresponsive services and unexpected spikes in cost and utility consumption. In addition, combining CoT reasoning with RAG-based techniques can lead to significant processing delays that are too slow to deliver a satisfactory user experience.

Accordingly, improved systems and methods that employ continuous RAG with CoT (CRAG-CoT) are provided herein. In some examples, the CRAG-CoT system combines and extends the capabilities of LLMs by enabling continuous, controlled interactions between language models and backend systems. In some examples, the CRAG-CoT system provides a framework for LLMs to perform multi-step reasoning while accessing data sources, overcoming key limitations of existing prompt-response, RAG, and CoT systems. In some examples, the CRAG-CoT system utilizes a standardized syntax for backend interaction, allowing LLMs to progressively build knowledge through multiple searches while maintaining clear chains of reasoning. In some examples, the CRAG-CoT architecture enables the development of sophisticated AI services with predictable performance characteristics, reduced hallucination risk, and efficient resource utilization.

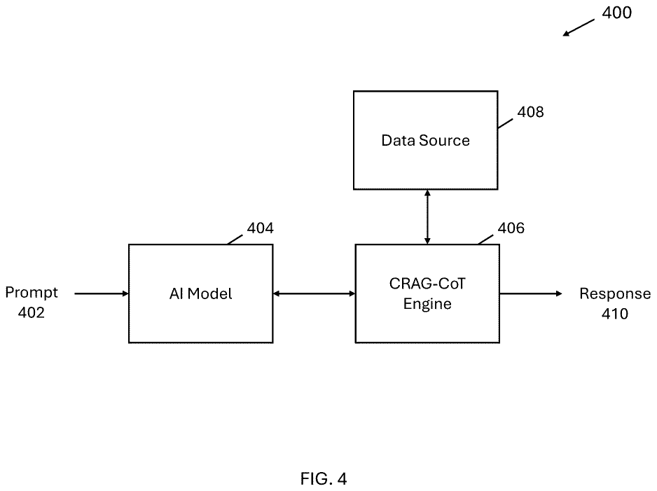

FIG. 4 is a block diagram of a CRAG-CoT system 400 in accordance with aspects described herein. As shown, the system 400 includes an AI model 404, a CRAG-CoT engine 406 and a data source 408. In some examples, the CRAG-CoT engine 406 is implemented by one or more application servers. Each application server may comprise software components that can be deployed at one or more data centers in one or more geographic locations, for example. The software components can comprise subcomponents that can execute on the same or on a different individual data processing apparatus. In some examples, the data source 408 is a vectorized database, a backend web service, or both. In some examples, the data source 408 includes one or more databases that reside in one or more physical storage systems in one or more geographic locations.

In some examples, the AI model 404 is a generative pretrained transformer (GPT) model. In some examples, the AI model 404 is a large language model (LLM). The AI model 404 may include model types, such as, for example: a gradient boosted random forest, a regression, a neural network, a decision tree, a support vector machine, a Bayesian network, or other suitable types of models. In some examples, the AI model 404 is a general model. In some examples, the AI model 404 is specifically trained for a specialized application or use-case.

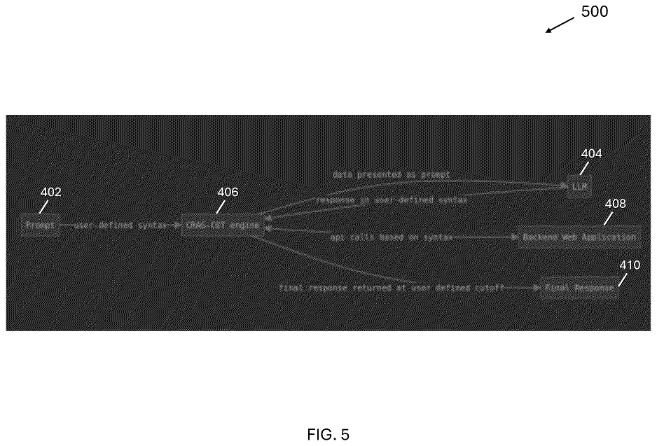

FIG. 5 illustrates an a flow process 500 of the CRAG-CoT system 400 in accordance with aspects described herein. The input prompt 402 is delivered to the CRAG-CoT engine 406. Based on the input prompt 402, the CRAG-CoT engine 406 generates a plurality of CoT reasoning steps. In some examples, each reasoning step corresponds to at least one application programming interface (API) call that is used to search the data source 408 (e.g., via a backend search tool). The data source 408 is configured to return the search results to the CRAG-CoT engine 406. In some examples, the search results associated with each reasoning step are stored (or saved) in one or more data baskets of the CRAG-CoT engine 406.

After reaching a cutoff limit, the CRAG-CoT engine 406 is configured to present the reasoning steps, the associated search results, and the user-defined syntax to the AI model 404 to generate the final response 410. In some examples, the cutoff limit corresponds to a predetermined number of reasoning steps (e.g., 3, 10, 100, etc.). In some examples, the cutoff limit corresponds to a predetermined time period (e.g., 10 ms, 5 secs, 1 min, etc.). In some examples, the cutoff limit is defined by the user (e.g., via the input prompt 402). In some examples, the cutoff limit is dynamically set by the CRAG-CoT engine 406 based on the complexity of the input prompt 402.

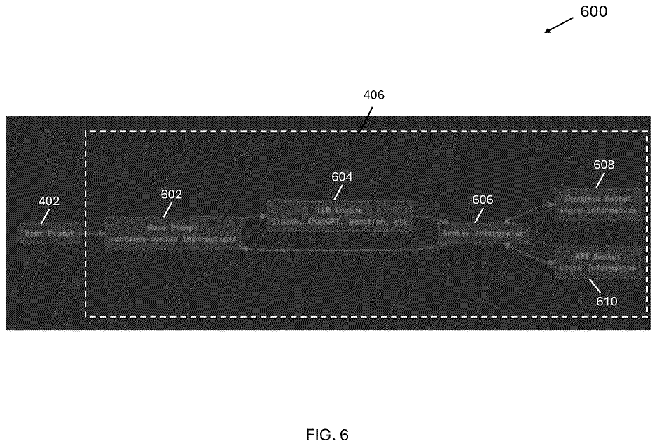

FIG. 6 illustrates a block diagram of the CRAG-CoT engine 406 in accordance with aspects described herein. As shown, the CRAG-CoT engine 406 includes an LLM engine 604, a syntax interpreter 606, a thoughts basket 608, and an API basket 610. In some examples, the LLM engine 604 corresponds to the AI model 404. However, in other examples, the LLM engine 604 may correspond to different AI models (e.g., LLMs such as Claude, ChatGPT, Memotron, etc.).

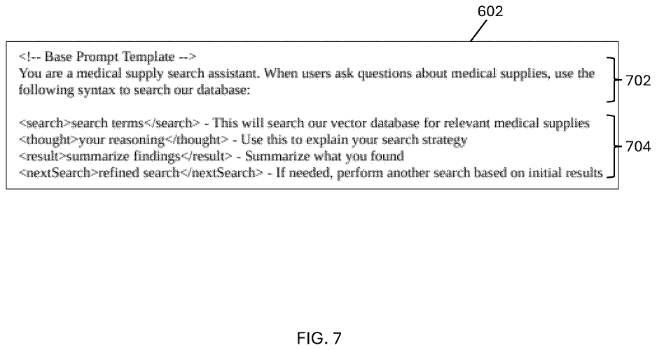

A base prompt 602 is used to instruct (or guide) the LLM engine 604 in performing the CRAG-CoT process. In some examples, the base prompt 602 corresponds to a specific application or scenario that the system 400 (or AI model 404) is being used for. For example, FIG. 7 illustrates a base prompt 602 relating to a medical supply search application. The illustrated base prompt 602 includes a contextual instruction section 702 and a syntax instruction section 704. The contextual instruction section 702 provides contextual information to the LLM engine 604 (e.g., “You are a medical supply search assistant.”). Likewise, the contextual instruction section 702 may include instructions that direct the operation of the LLM engine 604 (e.g., “When users ask questions about medical supplies, use the following syntax to search our database.”). The syntax instruction section 704 provides specific syntax rules for the LLM engine 604. In some examples, each syntax rules includes a template and a description of how the LLM engine 604 should populate the template. A syntax rule may also include a description of how each syntax instruction will be used by the CRAG-CoT engine 406. For example, the syntax instruction section 704 may include a search instruction (e.g., “<search>search terms</search>—This will search our vector database for relevant medical supplies”), a thought instruction (e.g., “<thought>your reasoning</thought>—Use this to explain your search strategy”), a result instruction (e.g., “<result>summarize findings</result>—Summarize what you found”), and a follow-on search instruction (<nextSearch>refined search</nextSearch>—If needed, perform another search based on initial results”).

In some examples, the base prompt 602 is configured by the user or an operator of the system 100 (or AI model 400). For example, the base prompt 602 may be configured with the expectation that prompts received from users (e.g., input prompt 402) will correspond to the specific application/scenario identified in the contextual instruction section 702. In some examples, the syntax instruction section 704 remains fixed regardless of variations in the contextual instruction section 702 (i.e., the same syntax instructions/rules can be used for different applications or scenarios). In some examples, the syntax instruction section 704 varies based on the type of application/scenario identified in the contextual information section 702. In some examples, the base prompt 602 is dynamically generated by the CRAG-CoT engine 406 based on the input prompt 402 received from the user. For example, the CRAG-CoT engine 406 may instruct the LLM engine 604 to identify contextual information associated with the input prompt 402 in order to generate the contextual instruction section 702 of the base prompt 602. In some examples, the CRAG-CoT engine 406 may instruct the LLM engine 604 (or another AI model) to generate the base prompt 602 (or the contextual information section 702) based on the input prompt 402.

The input prompt 402 is provided to the LLM engine 604 to initiate the CRAG-CoT process (i.e., following the base prompt 602). For example, in the medical supply search application example described above, the input prompt 402 may be a request for information relating to medical supplies (e.g., “I need supplies for wound care.”). Upon receiving the input prompt 402, the LLM engine 604 begins to perform a CoT reasoning process in view of the instructions included in the base prompt 602. In some examples, the LLM engine 604 is configured to generate a plurality of reasoning steps as part of the CoT reasoning process. Each reasoning step may include a “thought” that explains or otherwise describes the thought process of the LLM engine 604 in addressing the input prompt 402. Likewise, each reasoning step may include a “search” that is responsive to the thought. In some examples, each search corresponds to an API call that is used by the LLM engine 604 to search the data source 408. The results of the search may be provided to the LLM engine 604 for analysis. Each reasoning step may include a “result” that summarizes the analysis performed by the LLM engine 604. In some examples, the result includes another thought that is used to perform a subsequent search. For example, the result may indicate that insufficient information was returned to properly address the thought (or the prompt 402). In such cases, the LLM engine 604 may generate a subsequent search to be performed based on the deficiencies of the prior search.

In some examples, the syntax interpreter 606 is configured to sort the output of the LLM engine 604 (e.g., the thoughts, searches, and results) into the thoughts basket 608 and the API basket 610. For example, the syntax interpreter 606 may be configured (or trained) to identify syntax markers (e.g., <search>, <thought>, etc.) in the text outputs of the LLM engine 604 to perform the sorting. In some examples, the thoughts and results produced by the LLM engine 604 for each reasoning step are stored (or saved) in the thought basket 608. Likewise, the search results received from the data source 408 (e.g., via API calls) for each reasoning step are stored (or saved) in the API basket 610. In some examples, the corresponding search calls (or search criteria) produced by the LLM engine 604 are saved in the API basket 610. In some examples, the syntax interpreter 606 sorts the output of the LLM engine 604 in real-time. In some examples, the syntax interpreter 606 sorts the output of the LLM engine 604 after the completion of each reasoning step or the plurality of reasoning steps.

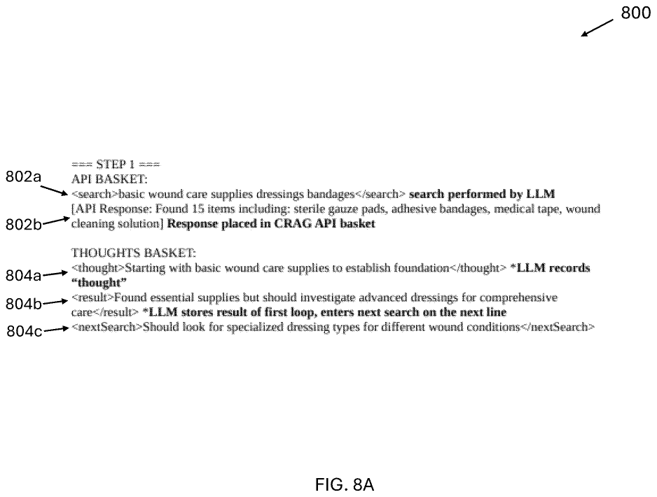

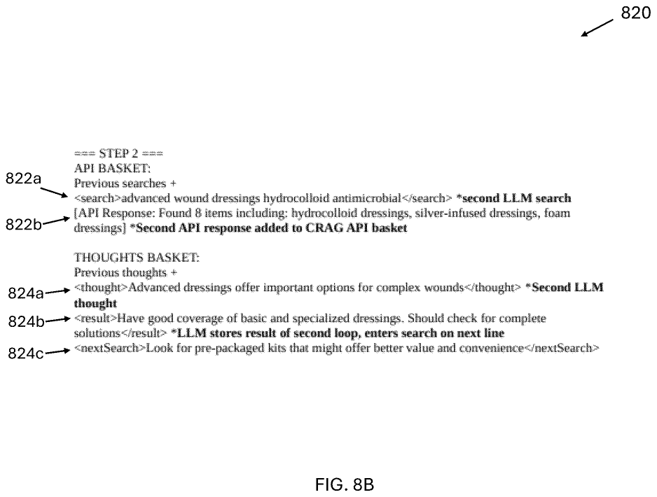

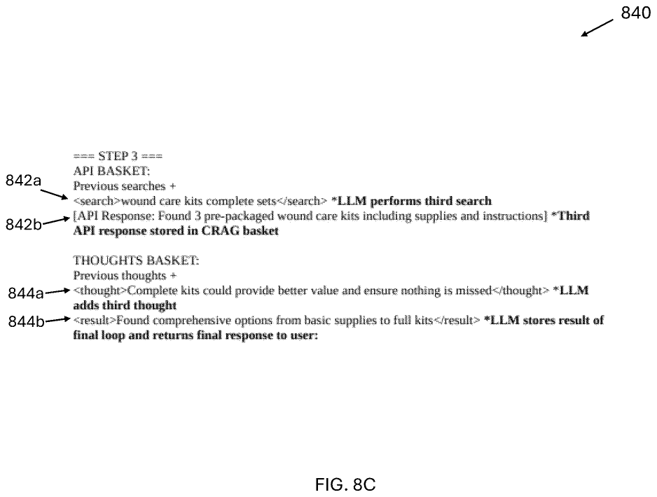

FIGS. 8A-8C illustrate example reasoning steps that may be generated by the LLM engine 604 during the CRAG-CoT process.

FIG. 8A illustrates a first reasoning step 800 that is generated based on the input prompt 402 (e.g., “I need supplies for wound care.”). As shown, the first reasoning step 800 includes a search 802a (e.g., “basic wound care supplies dressings bandages”) and search results 802b (e.g., “Found 15 items including: sterile gauze pads, adhesive bandages, medical tape, wound cleaning solution”). In some examples, the search 802a corresponds to an API call that is used to search the data source 408 and the search results 802b correspond to the results returned from the data source 408 via the API. The search results 802b are delivered by the syntax interpreter 606 to the API basket 610 to be saved/stored. In some examples, the search 802a is also delivered by the syntax interpreter 606 to the API basket 610 to be saved/stored.

The first reasoning step 800 further includes a thought 804a (e.g., “Starting with basic wound care supplies to establish foundation”), a result 804b (e.g., “Found essential supplies but should investigate advanced dressings for comprehensive care”), and a subsequent search 804c (e.g., “Should look for specialized dressing types for different wound conditions”). The thought 804a describes the reasoning behind the search 802a. In some examples, the criteria of the search 802a is derived from the thought 804a by the LLM engine 604. In some examples, the textual content of the thought 804a is generated based on the criteria of the search 802a by the LLM engine 604. The thought 804a is delivered by the syntax interpreter 606 to the thought basket 608 to be saved/stored. The result 804b describes the search results 802b. In some examples, the result 804b assess the results 802b in view of the thought 804a. In some examples, the result 804b includes a recommendation (or instruction) for the next reasoning step (or search). The result 804b is delivered by the syntax interpreter 606 to the thought basket 608 to be saved/stored. The subsequent search 804c describes a follow-on search to be performed based on recommendation/instruction included in the result 804b. In some examples, the search 802a, search results 802b, thought 804a, and result 804b correspond to a first reasoning loop. As such, the subsequent search 804c may be used to initiate a second reasoning loop.

FIG. 8B illustrates a second reasoning step 820 that is generated based on the subsequent search 804c (e.g., “Should look for specialized dressing types for different wound conditions”) from the first reasoning step 800. In other examples, the second reasoning step 820 may be generated based on other CoT logic applied by the LLM engine 604 (e.g., when the first reasoning step 800 does not include a subsequent search). As shown, the second reasoning step 820 includes a search 822a (e.g., “advanced wound dressings hydrocolloid antimicrobial”) and search results 822b (e.g., “Found 8 items including: hydrocolloid dressings, silver-infused dressings, foam dressings”). The search results 822b are delivered by the syntax interpreter 606 to the API basket 610 to be saved/stored. In some examples, the search 822a is also delivered by the syntax interpreter 606 to the API basket 610 to be saved/stored.

The second reasoning step 820 further includes a thought 824a (e.g., “Advanced dressings offer important options for complex wounds”), a result 824b (e.g., “Have good coverage of basic and specialized dressings. Should check for complete solutions”), and a subsequent search 824c (e.g., “Look for pre-packaged kits that might offer better value and convenience”). The thought 824a and the result 824b are delivered by the syntax interpreter 606 to the thought basket 608 to be saved/stored. In some examples, the search 822a, search results 822b, thought 824a, and result 824b correspond to a second reasoning loop. As such, the subsequent search 824c may be used to initiate a third reasoning loop.

FIG. 8C illustrates a third reasoning step 840 that is generated based on the subsequent search 824c (e.g., “Look for pre-packaged kits that might offer better value and convenience”) from the second reasoning step 820. In other examples, the third reasoning step 840 may be generated based on other CoT logic applied by the LLM engine 604 (e.g., when the second reasoning step 820 does not include a subsequent search). As shown, the third reasoning step 840 includes a search 842a (e.g., “wound care kits complete sets”) and search results 842b (e.g., “Found 3 pre-packaged wound care kits including supplies and instructions”). The search results 842b are delivered by the syntax interpreter 606 to the API basket 610 to be saved/stored. In some examples, the search 842a is also delivered by the syntax interpreter 606 to the API basket 610 to be saved/stored.

The third reasoning step 840 further includes a thought 844a (e.g., “Complete kits could provide better value and ensure nothing is missed”) and a result 844b (e.g., “Found comprehensive options from basic supplies to full kits”). The thought 844a and the result 844b are delivered by the syntax interpreter 606 to the thought basket 608 to be saved/stored. In some examples, the search 842a, search results 842b, thought 844a, and result 844b correspond to a third reasoning loop.

In some examples, the LLM engine 604 is configured to end the reasoning steps when no subsequent searches are generated. For example, based on the result 844b, the LLM engine 604 may determine that no further reasoning steps are required to adequately address the prompt 402. In some examples, the LLM engine 604 continues to generate reasoning steps until a cutoff limit is reached, as described above. For example, the LLM engine 604 may continue to generate reasoning steps until a predetermined number of reasoning steps have been generated, a predetermined processing time has expired, etc. In some examples, the cutoff limit is defined by the user (e.g., in prompt 402) or an operator of the system 400 (or the AI model 404). In some examples, the cutoff limit is dynamically generated by the CRAG-CoT engine 406 based on the prompt 402.

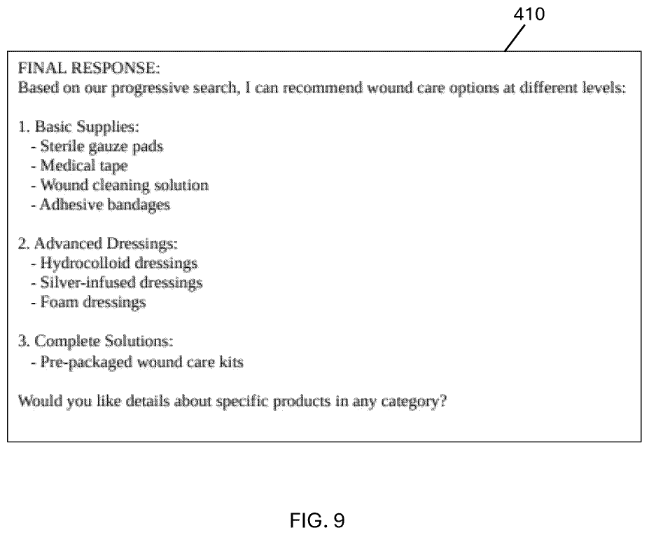

Once it is determined that the final reasoning step has been generated (e.g., based on the results produced by the LLM engine 604 or the cutoff limit), the contents (or data) of the thoughts basket 608 and the API basket 610 are delivered to the AI model 404 to generate the final response 410. In some examples, the data from baskets 608, 610 is provided to the AI model 404 with the input prompt 402. In some examples, the data from baskets 608, 610 is provided to the AI model 404 as a prompt. For example, the AI model 404 may be prompted to address the input prompt 402 based on the data from the baskets 608, 610. In some examples, the AI model 404 is configured (or prompted) to generate the final response 410 using a specific user-defined syntax included in the prompt 402. FIG. 9 illustrates an example final response 410 generated by the AI model 404. The illustrated response 410 corresponds to the example reasoning steps 800, 820, 840 of FIGS. 8A-8C and the corresponding data of baskets 608, 610.

As described above, the system 400 combines retrieval augmentation and CoT, giving the AI model 404 (or the LLM engine 604) the ability to progressively search for additional data as they engage in multi-step cognition. In some examples, the system 400 adds improved tool-use capabilities by allowing the LLM engine 604 to upload and/or edit data in a backend web application (e.g., the data source 408). For example, the LLM engine 604 may use direct API calls (e.g., PUT, POST, DELETE, etc.) to modify data in the data source 408. In some examples, the CRAG-CoT engine 406 is compatible with a variety of AI models, providing advanced processing capabilities without the need for advanced or specialized training. Further, the CRAG-CoT engine 406 provides substantial improvements in processing time and predictability (e.g., via cutoff limits). As such, the CRAG-CoT engine 406 can reduce the costs and resource utilization associated with advanced reasoning tasks. In some examples, the use of continuous RAG enables the system 400 to provide additional protection from model hallucination over typical retrieval augmentation systems. In addition, the system 400 expands the technologies and sources available for data retrieval. For example, the CRAG-CoT engine 406 may enable data retrieval from vector databases, API calls, or a combination of both formats. For example, the CRAG-CoT engine 406 may use natural language based search results from an embedding model (e.g., Qwen 3 Embed, BGE M3, etc.) or retrieve data from external data sources via API interactions. In some examples, the system 400 operates with a reduced memory footprint relative to typical CoT systems (or models). For example, typical “chat with tool calling” systems using smaller AI models (e.g., Qwen 2.5 7 B with ˜7 GB memory footprint) are unable to perform complex analysis tasks such as, for example, analyzing spreadsheets using tool calls. The spreadsheet data cannot fit within the model's context window, and attempting to paste the entire spreadsheet overwhelms the system. To handle such complex analysis, traditional systems would require much larger models (e.g., 30 B-304 B parameters) that need 30 GB-304 GB of memory to run, making them expensive and resource-intensive. Conversely, the CRAG-CoT engine 406 ingests the spreadsheet data into a retrieval engine, allowing smaller models (e/g. Qwen 3 7 B) to use the CoT logic phase to plan multiple targeted queries, review and reason about results systematically, and then present comprehensive analysis to the user. In addition, the system 400 offers the ability to create or design complex services using AI models (e.g., LLMs). For example, as described in greater detail below, the system 400 may implement an access control service.

The CRAG-CoT architecture and process is domain-agnostic, capable of processing and analyzing any structured or unstructured data that can be vectorized or made searchable. Examples of uses include, but are not limited to: enterprise data (e.g., inventory, logistics, operations, etc.), scientific research and analysis, healthcare records and medical data, social media and communication feeds, financial transactions and market data, industrial internet-of-things (IoT) sensor data, supply chain management, educational content and research materials, legal and compliance documentation, customer relationship management, media and content management, and security and access control systems. The ability of the CRAG-CoT architecture/process to combine natural language processing with structured data analysis makes it uniquely suitable for any domain where information retrieval, analysis, and decision-making are required (or useful). The architecture's modular design allows it to be implemented across various scales, from single-purpose applications to enterprise-wide distributed systems.

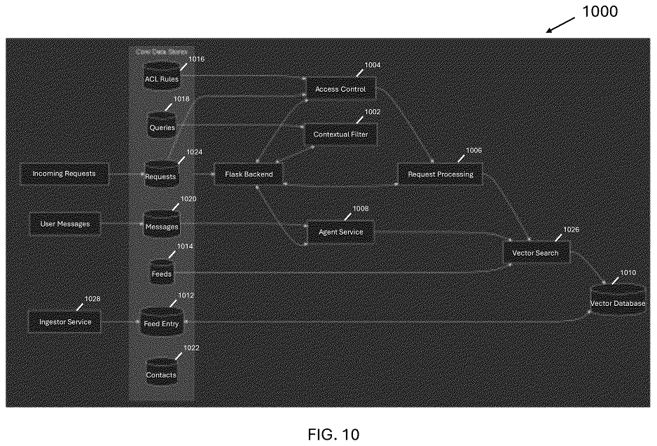

In some examples, multiple CRAG-CoT engines are implemented with multiple AI models (e.g., LLMs) to provided specialized services. FIG. 10 illustrates a block diagram of a CRAG-CoT system 1000 that is configured to provide a protocol for sharing information in accordance with aspects described herein. The system 1000 includes a contextual filter engine 1002, an access control service engine 1004, a request processing service engine 1006, and an agent service engine 1008. In some examples, each of the engines 1002-1008 are CRAG-CoT engines. The contextual filter engine 1002 is configured to evaluate query responses for helpfulness and can perform automated backend actions (e.g., friend request confirmations) based on predefined rules. The access control service engine 1004 is configured to evaluate access permissions using access control list (ACL) rules and can interact with backend systems to enforce permissions. The request processing service engine 1006 is configured to process structured requests according to ACL rules, perform vector searches, and generate responses for specific use cases (e.g., product searches). The agent service engine 1008 is configured to handle conversational interactions through messages, providing more flexible and open-ended responses while maintaining ability to interact with backend systems.

The system 1000 may include one or more data stores (or databases). In some examples, the system 1000 includes a vector database 1010, a feed entry database 1012, a feeds database 1014, an ACL rule database 1016, a query database 1018, a message database 1020, a contact database 1022, and a request database 1024. The vector database 1010 stores vector embeddings with periodic synchronization from feed entries. The feed entry database 1012 stores the primary content entries that get vectorized. The feeds database 1014 contains the source definitions/configurations for content and supports automated content categorization using machine learning models. In some examples, the feeds database 1014 utilizes Latent Dirichlet Allocation (LDA) to build models of potential content items and organize them automatically by topic. In some examples, the feeds database 1014 uses embedding models (e.g., BGE M3, Qwen 3 Embed, etc.) to enable users to provide natural language statements such as, for example, “videos about cats,” “quantum physics,” or “politics.” Each categorization method creates a list of feed entry contents ranked by semantic similarity to the topic or query. The ACL rule database 1016 includes rules that define access control and processing rules for different types of requests. The query database 1018 stores query definitions that can be evaluated by the contextual filter engine 1002. The messages database 1020 stores user messages for processing by the agent service engine 1008. The contact database 1022 stores contact management data. The request database 1024 stores incoming search/action requests.

The system 1000 may include one or more supporting services. In some examples, the system 1000 includes a vector search service 1026 and an ingestor service 1028. The vector search service 1026 is a centralized service for performing vector similarity searches across the vector database 1010 and may be utilized by multiple system components (e.g., CRAG-CoT engines). The ingestor service 1028 handles the ingestion of new entries into a feed entry database.

In some examples, a user of the system 1000 interacts with an agent (e.g., a chat interface) via the agent service engine 1008. The agent service engine 1008 is configured to interact with one or backend services on behalf of the user (e.g., using the CRAG-CoT process). In some examples, the agent service engine 1008 can manage contacts (or any other object defined in the backend), make and evaluate searches of other nodes (e.g., other instances of the same system that are federated), and/or create, edit, summarize, and evaluate feeds and feed entries. In some examples, the ingestor service 1028 uses LLMs, speech-to-text models, image interpretation models, and other types of models to convert media or other forms of data into feed entries stored in the system (e.g., web application) and indexed by the vector database 1010. In some examples, the vector database 1010 can be used to construct “newsfeeds” of any form of data from natural language queries (e.g., “posts that are about dogs,” fitness videos that contain a humorous injury,” etc.).

In some examples, incoming queries from other nodes are evaluated against user-defined ACL rules by the access control service engine 1004. In some examples, this service is referred to as “natural language access control.” The access control service engine 1004 uses the CRAG-CoT process to evaluate access control statements (e.g., “only allow queries about feed items if a search reveals that we actually have them in stock”). In some examples, the access control service engine 1004 is configured to search the backend for relevant items before allowing or denying the incoming query. In some examples, the contextual filter engine 1002 is configured to evaluate query results based on their relevance to the search. In some examples, searches may be several sentences or more long and/or contain numbers of qualifiers (e.g., “I'm looking for a 1997 Ford Windstar head gasket,” “I'm also looking for a shop to install the head gasket and I don't want to work with any chains,” etc.). In some examples, the contextual filter engine 1002 highlights the most helpful, relevant responses and suppress or removes those that are unhelpful, dangerous, or illegal. In some examples, the access control service engine 1004 creates complex hierarchical rule structures (or “trees”) for managing responses. Based on goodness of fit analysis, the access control service engine routes incoming queries to different rule sets. Each rule can define a specific response type or persona, such as business-specific assistants (e.g., “You are the AI assistant for Burger Restaurant, our menu is . . . ” for local business queries), anti-spam responses (e.g., “Answer spammy incoming queries with generic response . . . ”), or character-based interactions, provided the rule is understood by the LLM configured to respond. The AI model responds according to the guidance specified in the matched rule.

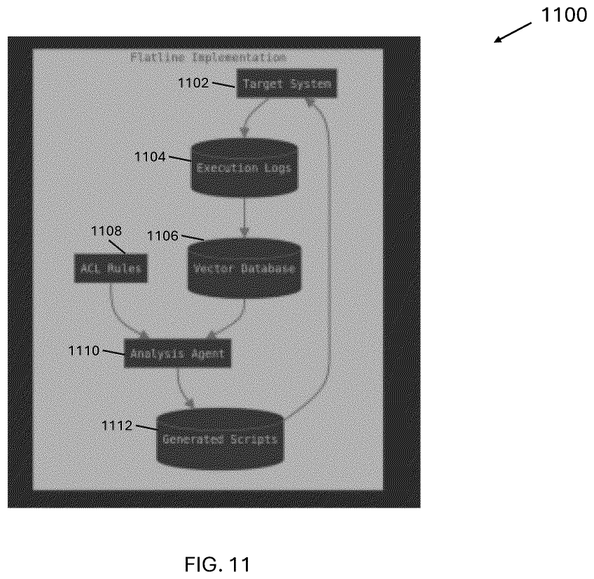

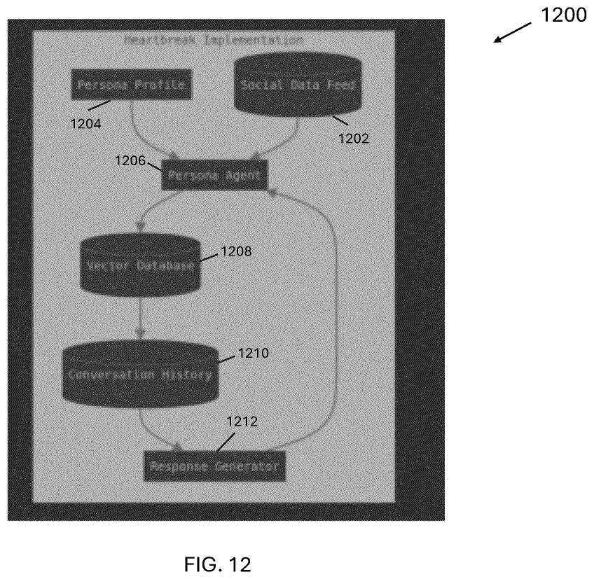

The CRAG-CoT architecture enables sophisticated system manipulation and interaction modeling through its ability to learn from historical data and progressively refine actions. FIGS. 11 and 12 illustrate example implementations which demonstrate the depth of the such capabilities.

FIG. 11 is a block diagram of a CRAG-CoT system 1100 configured to provide automated system analysis and disruption in accordance with aspects described herein. In some examples, the arrangement of the system 1100 is referred to as a “flatline” implementation. As shown, the system 1100 includes a target system 1102, an execution log database 1104, a vector database 1106, an ACL rules database 1108, an analysis agent 1110, and a generated script database 1112. The system 1100 provides direct integration with code execution pipelines, ACL-rule-guided script generation, iterative refinement based on execution results, vector storage of attempt logs for progressive learning, dynamic adjustment of approaches based on system responses, and real-time effectiveness analyses. In some examples, the analysis agent 1110 operates as an autonomous system assessment tool that can be tasked with evaluating system vulnerabilities or service disruption capabilities. The system 1100 implements a feedback loop where the analysis agent 1110 executes commands against the target system 1102, stores execution results in the execution log database 1104, and retrieves historical attempt data (both successful and failed) from the vector database 1106 for use in subsequent reasoning loops. This enables the CRAG-CoT system 1100 to progressively refine its approach based on prior execution outcomes, allowing for autonomous system analysis tasks such as identifying security vulnerabilities or testing system resilience.

FIG. 12 is a block diagram of a CRAG-CoT system 1200 configured to provide dynamic interaction modeling in accordance with aspects described herein. In some examples, the arrangement of the system 1200 is referred to as a “heartbreak” implementation. As shown, the system 1200 includes a social data feed database 1202, a persona profile 1204, a persona agent 1206, a vector database 1208, a conversation history database 1210, and a response generator 1212. In some examples, the system 1200 provides persona-based interaction generation, contextual response synthesis from stored interactions, vector-based retrieval of historical exchanges, real-time adaption to conversation dynamics, progressive refinement of interaction patterns, and comprehensive interaction state maintenance. In some examples, the system 1200 represents a dual-use capability that uses a CRAG-CoT agent (i.e., the persona agent 1206) to simulate realistic human interactions. Information about past interactions and persona characteristics that the agent 1206 is configured to emulate is stored in the vector database 1208 and retrieved by the CRAG-CoT engine to enable more sophisticated responses than existing solutions. The persona agent 1206 uses historical interaction data and persona profiles to generate contextually appropriate responses that maintain consistency with the assigned persona characteristics.

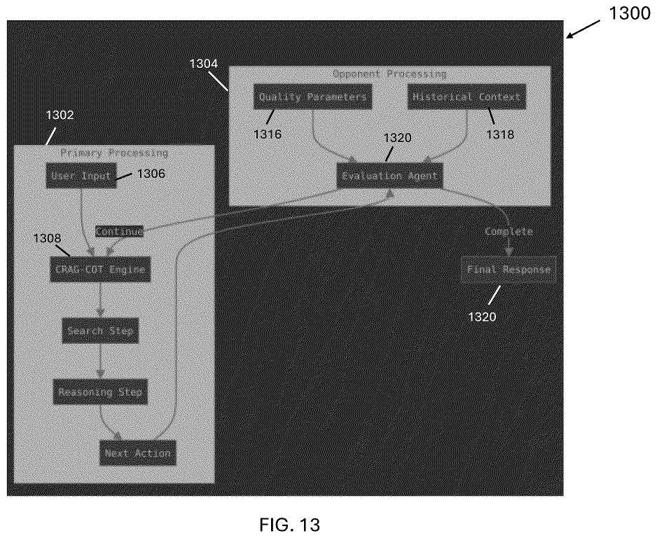

In some examples, rather than using a CRAG-CoT engine to cut off a final response or an LLM agent's reasoning to return a final response, two agent services may be combined with a CRAG-CoT engine and used for opponent processing. FIG. 13 illustrates a block diagram of an opponent-processing (OP) CRAG-CoT system 1300 in accordance with aspects described herein. In some examples, system 1300 includes a primary processing agent 1302 and an opponent (or secondary) processing agent 1304. In some examples, the primary processing agent 1302 is a CRAG-CoT based agent and the opponent processing agent 1304 is a non-CRAG-CoT based agent. As shown, the primary processing agent 1302 includes a CRAG-CoT engine 1308. In some examples, the primary processing agent 1302 engages in a search and summary loop (e.g., as described in relation to FIGS. 7 and 8A-C) initiated by an input prompt 1306 and the opponent processing agent 1304 decides when to stop the CoT reasoning of the primary processing agent 1302. In some examples, the opponent processing agent 1302 includes a quality parameters database 1316, a historical context database 1318, and evaluation agent 1320. In some examples, the opponent processing agent 1304 includes quality control guidelines and access to historical interaction data for evaluating and rejecting responses that might reveal the AI nature of the primary processing agent 1302. The opponent processing agent 1304 is configured to ensure that responses from the primary processing agent 1302 maintain consistent persona characteristics and do not exhibit behaviors that would identify the system as artificial intelligence to users interacting with it.

Provided below are several embodiments of systems and methods which describe various implementations of the CRAG-CoT architecture and process. The embodiments provided below are examples and are not intended to be limiting.

Embodiment 1. A system for enhanced model interaction including one or more processors and memory storing executable instructions. The instructions, when executed by the one or more processors, cause the system to receive input from one or more users or systems and process the input through a language model. The language model is configured to: generate structured search commands using a predefined syntax, maintain separate storage for API interactions and reasoning steps, generate intermediate search refinements based on previous results, accumulate and process multiple search results, and interact with one or more backend systems. The language model is configured to interact with backend systems through a syntax interpreter for processing structure commands, a vector search engine, and/or an API search engine. The language model is configured to generate responses incorporating both retrieved information and reasoning steps.

Embodiment 2. A method for continuous retrieval-augmented generation including receiving input data from one or more sources and processing the input data through a language model. The language model is used to generate one or more structured search commands, store the commands in an API basket, store reasoning steps in a thoughts basket, and generate subsequent searches based on previous results. The searches are executed through vector database queries, API calls, and/or backend system interactions. A progressive record is maintained of search results, reasoning steps, and intermediate conclusions. A final response is generated by incorporating the accumulated information.

Embodiment 3. A distributed information processing system including multiple nodes. The nodes are configured to process search requests, maintain local vector databases, and share information according to access control rules. One or more CRAG-CoT engines are used to implement language model-based access control evaluation, cross-node search capabilities, and security boundary maintenance. Periodic synchronization mechanisms are provided between feed entries and vector databases, system nodes, and backend data stores.

Embodiment 4. A multi-engine CRAG-CoT implementation system including a contextual filter engine, an access control engine, a request processing engine, and an agent service engine. The contextual filter engine is configured to evaluate query responses, process automated actions, and apply user-defined rules. The access control engine is configured to process permissions, evaluate access rules, and maintain security boundaries. The request processing engine is configured to handle structured searches, process vector queries, and generate responses. The agent service engine is configured to process conversational interactions, maintain context, and generate natural language responses.

Embodiment 5. A method for implementing secure distributed access in a CRAG-CoT system including receiving access control rules in a structured format and processing the rules through a language model. The rules are processed to generate enforcement parameters, evaluate access requests, and maintain security boundaries. The method further includes applying the generated parameters to search requests, manage data access, monitor cross-node interactions, and edit/store data. The method further includes maintaining audit records of access decisions, rule applications, and security events.

### Hierarchical Agent Collaboration for Enhanced Information Processing

The CRAG-CoT framework may be used to provide significant advancements in information processing and knowledge extraction technologies. In some examples, a modular extension to the CRAG-CoT framework is used to introduce hierarchical agent collaboration that transforms how search results are processed, analyzed, and synthesized.

Typical information retrieval systems face increasingly complex challenges in navigating the exponential growth of available data. While traditional search engines excel at finding relevant documents, they generally lack the ability to synthesize information across multiple sources, extract deep contextual understanding, and present cohesive analyses without significant human intervention.

As described above, the CRAG-CoT framework provides an improved approach to information retrieval by integrating vector search capabilities with tool-augmented retrieval processes. The CRAG-CoT framework provides significant improvements in search relevance and contextual understanding and presents new opportunities for enhancing information synthesis and knowledge extraction.

In some examples, a hierarchical agent collaboration (HAC) engine is used to build upon the capabilities of CRAG-CoT by introducing a multi-layered collaborative agent architecture that mimics the emergent intelligence of natural swarms. By distributing cognitive tasks across hierarchical agent networks, the HAC engine achieves superior information synthesis while dramatically reducing computational resource requirements.

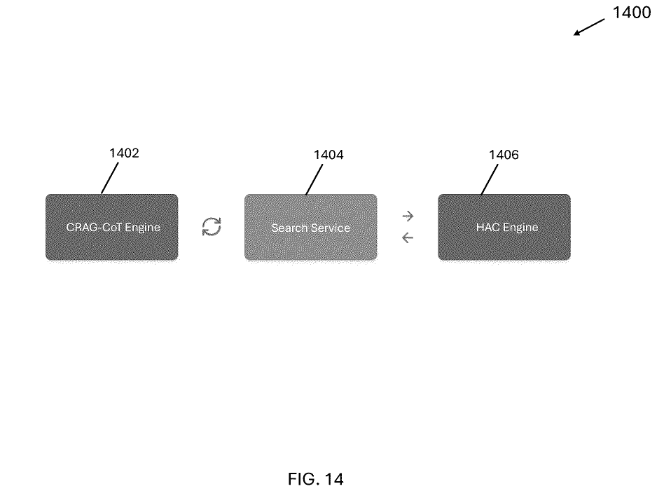

FIG. 14 is a block diagram of a HAC system 1400 in accordance with aspects described herein. As shown, the system 1400 includes a CRAG-CoT engine 1402, a search service 1404, and a HAC engine 1406. The HAC engine 1406 integrates seamlessly with CRAG-CoT engine 1402 as a modular extension, enhancing its existing information retrieval capabilities with advanced collaborative processing. In some examples, rather than including a CRAG-CoT engine, the system 1400 includes a CRAG-CoT integration layer that connects to existing CRAG-CoT engine implementations. In some examples, the search service 1404 is configured to process both vector and web search results. In some examples, an LLM agent running in the CRAG-CoT engine 1402 invokes the HAC service via search to review and preprocess large documents or other big datasets to retrieve and summarize specific information. The HAC engine 1406 includes a hierarchical agent distribution that is used to organize AI agents (e.g., LLM agents) into functional layers. This approach mimics the emergent intelligence of natural swarms, such as groups of ants that can solve complex problems like moving objects through mazes without any individual ant being aware of the overall task. Each ant follows only simple genetic and biochemical instructions like stand now, grab now, lift now, or follow scent trail back to nest. Similarly, no individual agent in the HAC system knows more than a fraction of the total information. Rather, they only know specific details that need to be captured to synthesize the final report from the content presented. This distributed approach allows very small individual models to complete data retrieval tasks that generally require much larger models in terms of parameter size and memory footprint. For example, the system can browse dozens of forum sites and retrieve a comprehensive list of all ground points for a specific car (e.g., a 2000 Saab 9-3), with each agent handling only a portion of the search and analysis. In some examples, a synthesis aggregation framework collects and consolidates agent outputs. A result optimization module refines final outputs for coherence and accuracy.

The flow of data through the system 1400 beings with a query submission (e.g., a user prompt) that is received by the CRAG-CoT engine 1402. The search service 1404 performs a search (e.g., a vector and/or web search) based on the query submission. The search results are distributed to a first level of agents within the HAC engine 1406. A progressive synthesis is performed through hierarchical agent levels of the HAC engine 1406. In some examples, the HAC engine 1406 is configured to generate a final report with comprehensive analysis.

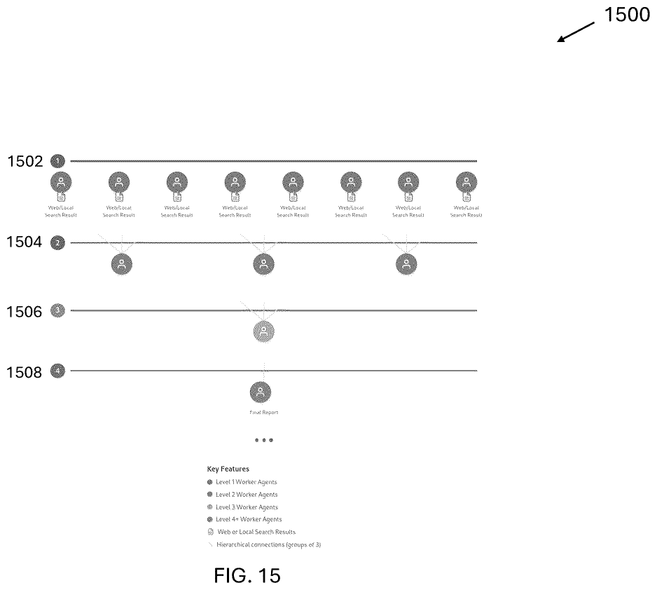

FIG. 15 illustrates a hierarchical agent organization structure 1500 in accordance with aspects described herein. In some examples, the structure 1500 corresponds to the hierarchical agent distribution of the HAC engine 1406. In some examples, a first level 1502 corresponds to a primary analysis level. The agents of the first level 1502 may be specialized agents configured to process individual search results to extract key information and contextual elements. In some examples, a second level 1504 corresponds to an intermediate synthesis level. The agents of the second level 1504 may be consolidation agents configured to integrate findings from multiple first level agents to identify patterns and relationships. In some examples, a third level 1506 corresponds to a conceptual integration level. The agent(s) of the third level 1506 may be higher-order processing agents configured to develop comprehensive conceptual models from the outputs of the second level agents. In some examples, a fourth level 1508 corresponds to a final synthesis level. The agent of the fourth level 1508 may be configured as a culmination agent configured to produce the final cohesive analysis. In some examples, the final analysis is presented as structured information ready for consumption.

In some examples, the HAC engine 1406 improves information synthesis capabilities through cross-document analysis by identifying and connecting related information across multiple sources. The HAC engine 1406 may provide contextual understanding by maintaining deeper contextual awareness throughout processing. In some examples, the HAC engine 1406 provides timeline reconstruction by accurately reconstructing chronological sequences from fragmented information. The HAC engine 1406 may provide concept mapping by generating comprehensive conceptual frameworks around query topics.

In some examples, the HAC engine 1406 achieves significant efficiency gains through reduced computational requirements by distributing processing across specialized agents. Likewise, efficiency gains are realized by the HAC engine 1406 through parallel processing (e.g., simultaneous information analysis at the first level 1502). In some examples, the HAC engine 1406 builds knowledge progressively while reducing redundant processing through incremental synthesis. In some examples, the HAC engine 1406 is configured to provide resource optimization by allocating computational resources based on information complexity.

The hierarchical agent structure of the HAC engine 1406 enables emergent capabilities beyond the sum of individual components. For example, the HAC engine 1406 provides insight generation by producing connections not explicitly present in source materials. In some examples, the HAC engine 1406 provides uncertainty management by identifying and resolving conflicting information through consensus mechanisms. In some examples, the HAC engine 1406 provides adaptive processing depth by automatically adjusting analysis depth based on information complexity. In some examples, the HAC engine 1406 implements cross-verification between agent levels to reduce errors and provide self-correction.

The HAC engine 1406 provides notable efficiency improvements when compared to existing deep research tools by acting as a force multiplier on the capability of large language models at lower parameter counts. In some examples, the HAC engine 1406 can achieve approximately 95% reduction in energy usage compared to OpenAI's deep research tools, achieved by utilizing 7 B parameter models in a hierarchical structure rather than much larger models. In some examples, the HAC engine 1406 achieved a 44% reduction in total tokens processed for comparable analysis depth. Through computational distribution, the HAC engine 1406 can provide more efficient resource allocation through parallel processing (e.g., at the first level 1502). In some examples, the HAC engine 1406 is configured to improve efficiency through near-linear efficiency scaling with increased query complexity. In some examples, the hierarchical approach eliminates the need for maintaining extremely large context windows in a single agent, instead distributing the cognitive load across specialized agents with focused tasks.

In one example, an instance of the HAC engine 1406 was tasked with analyzing complex literary texts with deliberately challenging conditions. The HAC engine 1406 was provided with a Late Middle English text version of Beowulf. The text was presented to the HAC engine 1406 in chunks having a randomized order. Despite these challenges, the HAC engine 1406 successfully reconstructed the complete timeline of narrative events in correct sequence, identified all key characters and their relationships, extracted significant symbols and motifs from the text, mapped the major themes and their development throughout the narrative, and retrieved several accurate direct quotes from the original text. This performance demonstrates the ability of the HAC engine 1406 to synthesize coherent understanding from fragmented and complex information sources, a task that typically requires significant human expertise or substantially more computational resources from traditional single-agent systems.

The HAC system 1400 provides significant advancements in information processing technology, leveraging hierarchical agent collaboration to achieve improved efficiency and effectiveness in knowledge synthesis. By building upon the CRAG-CoT framework, the HAC system 1400 provides a powerful solution for complex information analysis tasks while dramatically reducing computational resource requirements. As described above, the HAC system 1400 can accurately reconstruct complex narratives, identify subtle connections, and generate comprehensive analyses with reduced energy consumption.

Provided below are several embodiments of systems and methods which describe various implementations of the HAC architecture and process. The embodiments provided below are examples and are not intended to be limiting.

Embodiment 1. A system for processing information using multiple layers of intelligent agents including a search service interface configured to receive search results from one or more search engines and a hierarchical agent distribution system. The hierarchical agent distribution system is configured to organize a plurality of language model agents into a hierarchical structure with N levels, where N is a variable number determined by processing requirements. The hierarchical agent distribution system is further configured to distribute search results to a plurality of first-level agents for initial parallel processing, direct outputs from agents at each level i to a smaller number of agents at level i+1 for progressive synthesis, continue the hierarchical processing through any number of intermediate levels as determined by task complexity, and direct outputs from the penultimate level to a final level agent for comprehensive synthesis. The system further includes a synthesis aggregation framework configured to collect and consolidate agent outputs from each hierarchical level. A result optimization module is configured to refine the final synthesis output and an integration layer is configured to connect the system with existing information retrieval engines. The system processes information through specialized agents across a variable number of hierarchical levels to produce a comprehensive analysis with accuracy comparable to existing deep research tools while utilizing substantially fewer computational resources.

The plurality of language model agents comprise models with approximately 7 billion parameters. The hierarchical organization of agents enables information processing capabilities comparable to systems utilizing substantially larger language models. The system achieves at least a 40% reduction in total token usage compared to single-agent approaches utilizing larger language models. The system achieves at least a 90% reduction in energy consumption compared to existing deep research tools utilizing larger language models. These efficiency improvements are achieved through the specialized distribution of cognitive tasks across a variable-depth hierarchical agent network.

Embodiment 2. A method for processing information with enhanced efficiency including receiving search results from one or more search engines through a search service interface, determining an appropriate hierarchical depth N based on query complexity and processing requirements, and distributing the search results to a first level of multiple specialized agents for parallel initial processing. For each level i from 1 to N−1: outputs from level i agents are aggregated and directed to a smaller number of agents at level i+1 for progressive synthesis. The method further includes directing outputs from level N−1 to the final level N agent for comprehensive synthesis, optimizing the final synthesis output for coherence and accuracy, and delivering the optimized synthesis to a user interface. The method achieves information synthesis with accuracy comparable to existing deep research tools while reducing energy consumption by at least 90% through the use of smaller language models in a variable-depth hierarchical configuration.

Embodiment 3. A system for analyzing complex texts and reconstructing coherent information from fragmented sources. The system includes a content ingestion module, a hierarchical agent distribution system, a synthesis engine, and an output generation module. The content ingestion module configured to accept text input in various languages and formats, process text with chronological discontinuities, and handle complex linguistic structures and archaic language forms. The hierarchical agent distribution system is configured to determine an appropriate number of hierarchical levels N based on text complexity, organize language model agents into the determined N hierarchical levels, and assign specialized analysis tasks to agents based on their hierarchical position. The synthesis engine is configured to reconstruct chronological sequences from randomized text fragments, identify key entities and their relationships, extract thematic elements and symbolic patterns, and retrieve accurate direct quotations from source materials. The output generation module is configured to produce comprehensive analyses in user-specified formats. The system can process complex literary texts with deliberately challenging conditions and produce coherent analyses that identify narrative structure, characters, themes, and significant quotations using a variable number of hierarchical levels as required by the specific analysis task.

Embodiment 4. A system for enhancing the capabilities of existing information retrieval engines including an integration layer, a search service interface, a hierarchical agent organization module, a resource optimization controller, and a synthesis engine. The integration layer is configured to interface with existing search and vector retrieval engines. The search service interface is configured to process both vector search and web search results. The hierarchical agent organization module is configured to establish a variable-depth multi-level hierarchy of language model agents based on task requirements, define information flow pathways between hierarchical levels, and assign specialized processing roles to agents based on their hierarchical position. The resource optimization controller is configured to allocate computational resources based on query complexity, implement parallel processing for compatible tasks, and reduce redundant processing through incremental synthesis. The synthesis engine is configured to progressively build comprehensive analysis through any number of agent layers as determined by task complexity. The system extends the capabilities of existing information retrieval engines to include advanced information synthesis with accuracy comparable to leading deep research tools while consuming substantially less energy.

Embodiment 5. A method for synthesizing information from multiple sources including receiving a user query at an information retrieval engine, executing one or more searches to retrieve information relevant to the user query, determining an appropriate hierarchical depth N based on query complexity, establishing a hierarchical network of language model agents with N levels, where N is determined dynamically based on task requirements, and distributing search results to first-level agents for individual document analysis. For each level i from 1 to N−1: the outputs from level i agents are aggregated and distributed to level i+1 agents for progressively higher-order synthesis. The method further includes generating a final comprehensive synthesis through the level N agent, and optimizing the final synthesis for presentation to the user. Each hierarchical level performs specialized information processing functions that collectively enable comprehensive information synthesis with accuracy comparable to existing deep research tools while utilizing substantially less energy through the use of smaller language models.

### Hardware and Software Implementations

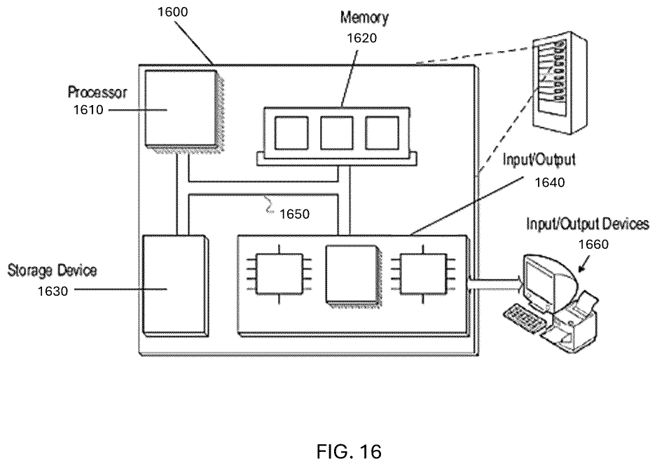

FIG. 16 is a block diagram of an example computer system 1600 that may be used in implementing the systems and methods described herein. For example, one or more computer systems, such as the computer system 1600, may be operable to perform the operations of the engines and models described herein. General-purpose computers, network appliances, mobile devices, or other electronic systems may also include at least portions of the system 1600. The system 1600 includes a processor 1610, a memory 1620, a storage device 1630, and an input/output device 1640. Each of the components 1610, 1620, 1630, and 1640 may be interconnected, for example, using a system bus 1650. The processor 1610 is capable of processing instructions for execution within the system 1600. In some implementations, the processor 1610 is a single-threaded processor. In some implementations, the processor 1610 is a multi-threaded processor. The processor 1610 is capable of processing instructions stored in the memory 1620 or on the storage device 1630.

The memory 1620 stores information within the system 1600. In some implementations, the memory 1620 is a non-transitory computer-readable medium. In some implementations, the memory 1620 is a volatile memory unit. In some implementations, the memory 1620 is a non-volatile memory unit. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

The storage device 1630 is capable of providing mass storage for the system 1600. In some implementations, the storage device 1630 is a non-transitory computer-readable medium. In various different implementations, the storage device 1630 may include, for example, a hard disk device, an optical disk device, a solid-date drive, a flash drive, or some other large capacity storage device. For example, the storage device may store long-term data (e.g., database data, file system data, etc.). The input/output device 1640 provides input/output operations for the system 1600. In some implementations, the input/output device 1640 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1660. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1630 may be implemented in a distributed way over a network, such as a server farm or a set of widely distributed servers, or may be implemented in a single computing device.

Although an example processing system has been described in FIG. 16, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated from the described processes.

The phraseology and terminology used herein is for the purpose of description and should not be regarded as limiting.

The indefinite articles “a” and “an,” as used in the specification, unless clearly indicated to the contrary, should be understood to mean “at least one.” The phrase “and/or,” as used in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. In general, the term “or” as used shall only be interpreted as indicating exclusive alternatives (i.e. “one or the other but not both”) when preceded by terms of exclusivity, such as “either,” “one of,” “only one of,” or “exactly one of.”

As used in the specification, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method of providing continuous retrieval-augmented generation chain-of-thought (CRAG-CoT) processing for an artificial intelligence (AI) model, comprising:
receiving an input prompt;
instructing a first AI model to assess the input prompt using a base prompt, the base prompt including syntax instructions for intermediate responses generated by the first AI model;
generating, via the first AI model, a plurality of reasoning steps using the syntax instructions of the base prompt;
retrieving data from at least one data source corresponding to each reasoning step of the plurality of reasoning steps;
providing at least a portion of the plurality of reasoning steps and the retrieved data to a second AI model; and
generating, via the second AI model, a final response based on the input prompt.

2. The computer-implemented method of claim 1, wherein the first AI model and the second AI model are the same AI model.

3. The computer-implemented method of claim 1, wherein at least one of the first AI model and the second AI model is a large language model (LLM).

4. The computer-implemented method of claim 1, wherein the plurality of reasoning steps correspond to chain-of-thought (CoT) processing steps.

5. The computer-implemented method of claim 1, wherein retrieving data from the at least one data source corresponding to each reasoning step of the plurality of reasoning steps includes using at least one application programming interface (API) to search the at least one data source.

6. The computer-implemented method of claim 5, wherein at least one API call is generated for each reasoning step of the plurality of reasoning steps.

7. The computer-implemented method of claim 1, wherein the at least one data source includes at least one of a vectorized database and a backend web application.

8. The computer-implemented method of claim 1, wherein each reasoning step of the plurality of reasoning steps includes a search response, a thought response, and a result response generated by the first AI model.

9. The computer-implemented method of claim 8, wherein the syntax instructions include formatting for each search response, thought response, and result response generated by the first AI model.

10. The computer-implemented method of claim 8, wherein retrieving data from the at least one data source corresponding to each reasoning step of the plurality of reasoning steps includes searching the at least one data source using the corresponding search response.

11. The computer-implemented method of claim 10, further comprising:
sorting, via a syntax interpreter, the retrieved data for each search response into a first data basket and the corresponding thought and result responses into a second data basket.

12. The computer-implemented method of claim 11, wherein providing at least a portion of the plurality of reasoning steps and the retrieved data to the second AI model includes providing the data of the first and second data baskets to the second AI model.

13. A system for providing continuous retrieval-augmented generation chain-of-thought (CRAG-CoT) processing for an artificial intelligence (AI) model, comprising:
at least one memory for storing computer-executable instructions; and
at least one processor for executing the instructions stored on the at least one memory, wherein execution of the instructions programs the at least one processor to perform operations comprising:
receiving an input prompt;
instructing a first AI model to assess the input prompt using a base prompt, the base prompt including syntax instructions for intermediate responses generated by the first AI model;
generating, via the first AI model, a plurality of reasoning steps using the syntax instructions of the base prompt;
retrieving data from at least one data source corresponding to each reasoning step of the plurality of reasoning steps;
providing at least a portion of the plurality of reasoning steps and the retrieved data to a second AI model; and
generating, via the second AI model, a final response based on the input prompt.

14. The system of claim 13, wherein the first AI model and the second AI model are the same AI model.

15. The system of claim 13, wherein at least one of the first AI model and the second AI model is a large language model (LLM).

16. The system of claim 13, wherein the plurality of reasoning steps correspond to chain-of-thought (CoT) processing steps.

17. The system of claim 13, wherein retrieving data from the at least one data source corresponding to each reasoning step of the plurality of reasoning steps includes using at least one application programming interface (API) to search the at least one data source.

18. The system of claim 17, wherein at least one API call is generated for each reasoning step of the plurality of reasoning steps.

19. The system of claim 13, wherein the at least one data source includes at least one of a vectorized database and a backend web application.

20. The system of claim 13, wherein each reasoning step of the plurality of reasoning steps includes a search response, a thought response, and a result response generated by the first AI model.

21. The system of claim 20, wherein the syntax instructions of the base prompt include formatting for each search response, thought response, and result response generated by the first AI model.

22. The system of claim 20, wherein retrieving data from the at least one data source corresponding to each reasoning step of the plurality of reasoning steps includes searching the at least one data source using the corresponding search response.

23. The system of claim 22, further comprising:
a syntax interpreter configured to sort the retrieved data for each search response into a first data basket and the corresponding thought and result responses into a second data basket.

24. The system of claim 23, wherein providing at least a portion of the plurality of reasoning steps and the retrieved data to the second AI model includes providing the data of the first and second data baskets to the second AI model.
